(19) United States
(12) Patent Application Publication
(10) Pub. No.: US 2006/0229901 A1
(43) Pub. Date: Oct. 12, 2006

(54) Method of facilitating social communication

(75) Inventors: Michael G. Dwyer, Oxnard, CA (US); Matthew Dwyer, Long Beach, NY (US); David Moldavon, Los Angeles, CA (US)

Correspondence Address: TOPE-MCKAY & ASSOCIATES, 23852 PACIFIC COAST HIGHWAY #311, MALIBU, CA, 90265, US

(73) Assignee: Michael Dwyer

(21) Appl. No.: 11/229,105

(22) Filed: Sep. 16, 2005

Related U.S. Application Data
(63) Continuation-in-part of application No. 11/104,980, filed on Apr. 12, 2005.

(51) Int. Cl. G06Q 99/00

(52) U.S. Cl. 705/1

(57) ABSTRACT

A method of facilitating social communication from a person to a recipient is presented. Initially, a social communication device with a message is selected by the person. The message may be pre-affixed, random, or customizable. When the message is customizable, the person customizes the message. The person then attaches the social communication device with the delivery device for delivery to the recipient, thus facilitating social communication between the person and the recipient. The social communication device and the delivery device may be obtained from vendors such as persons, machines, displays, and dispensing racks. In one aspect, the social communication device is a label with a message and the delivery device is a beverage container. This combination is useful for facilitating communication in bars, clubs or public houses.

### RELATED APPLICATIONS

The present application is a continuation-in-part of U.S. patent application Ser. No. 11/104,980, filed Apr. 12, 2005 and titled “METHOD OF FACILITATING SOCIAL COMMUNICATION” by Dwyer.

### BACKGROUND

(1) Field of the Invention

The present invention relates to facilitating communication between people in a social setting, and more specifically to techniques for facilitating communication between people in a social setting utilizing a messaging device which may be delivered to the recipient of the communication.

(2) Description of Related Art

Many people feel intimidated when initiating face-to-face social communication with others (especially with strangers). In fact, most people suffer from some level of social anxiety, even in relaxed social settings. Thus, regardless of individuals' levels of familiarity with each other, in most social settings, there exists a need for an invention which would make initial and continued communication between people easier.

Traditional methods of communication include face-to-face encounters, letters, phone calls, email, and online dating services. However, each of these methods suffers from drawbacks. Phone calls and face-to-face conversation require that an individual possess a degree of social bravery. Email and letters require time to prepare, write, send, and respond to, which can be impractical in real-time social situations. Online dating services do not produce real-time results.

Another major drawback to conventional communication is the fear of awkwardness or rejection. Unfortunately, these fears often prevent an individual from initiating social communication with a desirable person. Nervousness, anxiety, and other factors may prevent individuals from initiating contact. These problems are present in our social scene and have not been alleviated by the prior art.

Some of the current solutions to the problem of initiating contact include personal advertisements and matchmaking websites and services. These solutions fail to facilitate real-time, face-to-face interaction. They do not allow the initiator to see the recipient's immediate response. In short, they act as a barrier between the individuals desiring communication and do not facilitate the human-to-human interaction offered by the present invention. Additionally, subscribing to a dating service is a substantial decision that requires an investment of time and money.

None of the prior methods allows a person (who would not otherwise be inclined to speak to another person) to send a message and observe that other person's reaction. This invention overcomes these challenges present in today's social and dating scenes.

Therefore, it would be desirable to provide a method of facilitating social communication between people by allowing people to send messages from a distance and view real-time results.

### SUMMARY

The present invention teaches a method of facilitating social communication from a person to a recipient. In one aspect, the method comprises an act of obtaining a social communication device having at least one message selected by the person, from a group consisting of: a pre-affixed message, a random message, and a fully or partially customizable message. When the message is customizable, an act of customizing the message is performed. Next, a delivery device is selected. Subsequently, acts are performed for attaching the social communication device with the delivery device and delivering the delivery device to the recipient. Thus, social communication is facilitated between people.

In another aspect, the act of obtaining the social communication device is obtained by utilizing a vendor.

In a further aspect, the vendor is selected from a group consisting of: a person, a vending machine, the Internet, a display, a computer, and a dispensing rack.

In still another aspect, the act of selecting a delivery device is obtained by use of a delivery device source.

In yet another aspect, the delivery device is selected from a group consisting of: a person, a machine, the Internet, a display, and a store.

In a still further aspect, the act of attaching the social communication device with the delivery device is performed with a mechanism selected from a group consisting of: a detachable attachment and a permanent adhesive.

In another aspect, the detachable attachment is selected from a group consisting of: an adhesive, a hanging attachment, a slotted attachment, and a clip.

In a further aspect, the delivery device is delivered to the recipient by a deliverer.

In yet another aspect, the deliverer is selected from a group consisting of: the person him/her-self, an agent/representative, and a machine.

In a still further aspect, the social communication device is selected from a group consisting of: a label, a tag, a sculpture, a machine, a figure, a card, a retainer for attaching a secondary message, and an object.

In a further aspect, the retainer is selected from a group consisting of: a sheath, a pocket, a backing, and an envelope.

In a still further aspect, the backing includes an adhesive, corner pockets, and at least one slit.

In another aspect, the message is selected from a group consisting of: a written message, an auditory message, a visual message, a scented message, and a flavored message.

In still another aspect, the secondary message is selected from a group consisting of a note, a card, a business card, money, a picture, a room key, and an object.

In a yet further aspect, the delivery device is selected from a group consisting of a smoking device, a drinking device, a contraceptive, a gelatin shot, a food container, and a coaster.

In still another aspect, the drinking device is selected from a group consisting of a bottle, a glass, a cup, a can, and a test tube.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a flowchart illustrating the acts involved in a method of facilitating social communication according to the present invention;

FIGS. 2(a) through 2(e) are illustrations of a non-limiting exemplary application of the acts of the invention, specifically showing the use of the invention in the context of a social meeting place such as a restaurant or bar;

FIGS. 3(a) through 3(c) are illustrations of non-limiting examples of mechanisms by which a social communication device may be distributed;

FIGS. 4(a) through 4(c) are illustrations of three non-limiting examples of labels for use in conjunction with the present invention, showing different patterns of application of adhesive material;

FIGS. 5(a) through 5(e) are illustrations of various non-limiting examples of social communication devices that may be attached with a delivery device;

FIGS. 6(a) through 6(f) are illustrations of non-limiting examples of messages in accordance with the present invention;

FIGS. 7(a) and 7(b) are illustrations of exemplary and non-limiting embodiments for attaching a social communication device to a delivery device;

FIGS. 8(a) through 8(d) are illustrations of non-limiting exemplary delivery devices for use in conjunction with the present invention;

FIGS. 9(a) through 9(c) illustrate non-limiting exemplary placements of social communication devices on various delivery devices;

FIGS. 10(a) and 10(b) are illustrations of a front and a rear view of an exemplary and non-limiting embodiment of a retainer for attaching a secondary message;

FIGS. 11 (a) through 11(c) illustrate three non-limiting embodiments of a backing for attaching a secondary message;

FIG. 12 illustrates a delivery device in the form of a coaster; and

FIG. 13 illustrates a detachable attachment in the form of a slotted attachment.

### DETAILED DESCRIPTION

The present invention relates to the field of interpersonal communication. The following description is presented to enable one of ordinary skill in the art to make and use the invention and to incorporate it in the context of particular applications. Various modifications, as well as a variety of uses in different applications, will be readily apparent to those skilled in the art and the general principles defined herein may be applied to a wide range of embodiments. Thus, the present invention is not intended to be limited to the embodiments presented, but is intended to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in U.S.C. Section 112, Paragraph 6. In particular, the use of “step of” or “act of” in the claims herein is not intended to invoke the provisions of 35 U.S.C. 112, Paragraph 6.

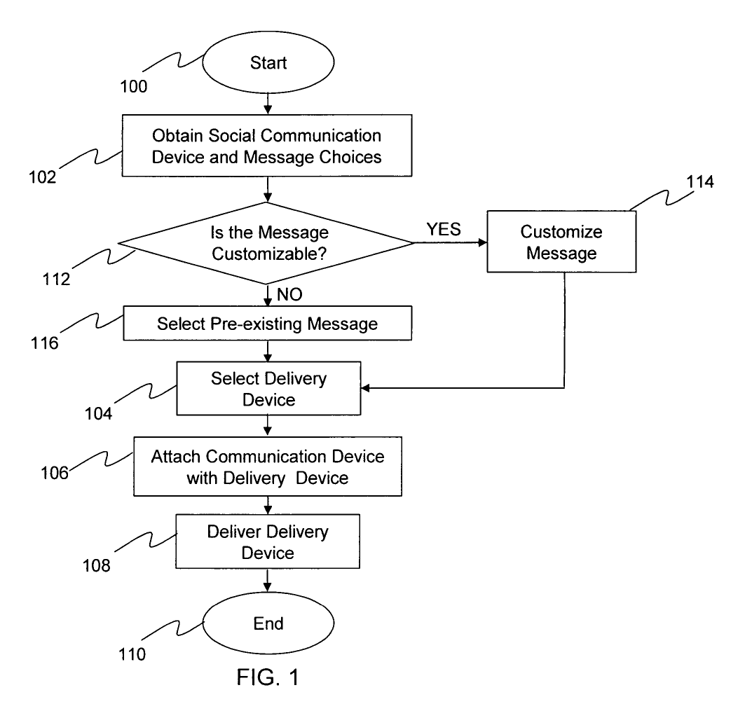

A flowchart of a method of interpersonal communication is presented in FIG. 1. As the method starts 100, a decision to communicate using a message is made. Next, an act of obtaining both a social communication device and an affixed message 102 is performed. At this point, the user has an option 112 of choosing a pre-existing message 116 or a partially or fully customizable message 114. Subsequently, an act of selecting a delivery device 104 is performed. Once the social communication device and the message have been obtained and the delivery device has been selected, an act of attaching the social communication device and the affixed message with the delivery device is performed 106. Subsequently, the delivery device is delivered to a recipient of the communication 108. At this point, the message has been communicated and the method ends 110.

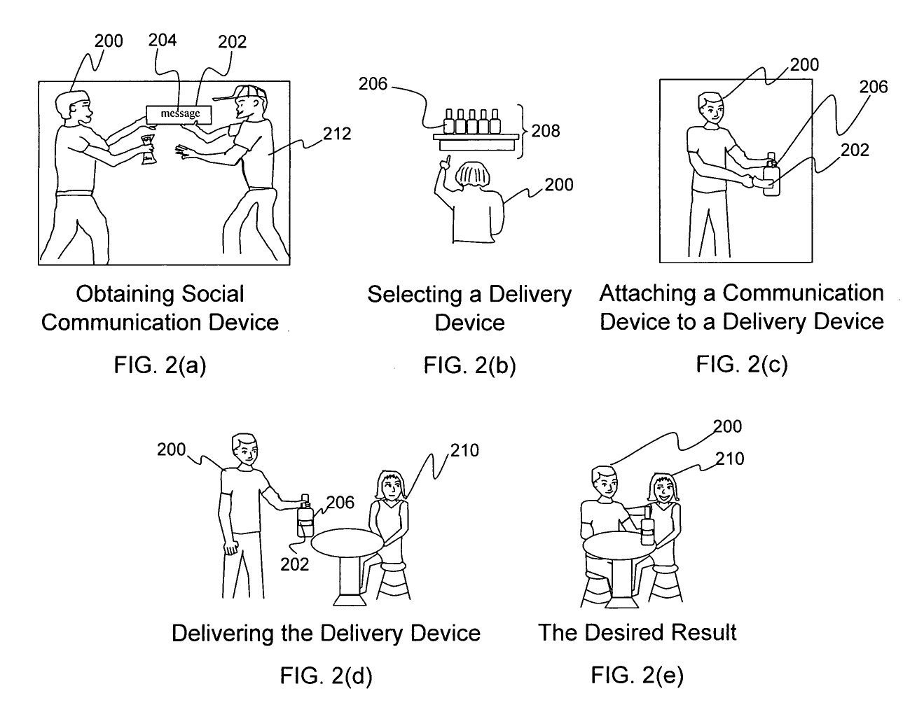

It will be apparent to one skilled in the art that the method just described can be applied to many situations. Some of the non-limiting examples of such situations are business, recruitment, or political events where business cards and professional information may be exchanged or social events where personal contact is desired. To further clarify the acts of the method, a non-limiting example of a person using the method in a social context is illustrated in FIG. 2(a) through FIG. 2(e).

FIG. 2(a) illustrates a person 200 obtaining a social communication device 202 (e.g., an adhesive label) from a vendor 212. In this non-limiting example, a message 204 (e.g., a pre-existing writing) is pre-affixed with the social communication device 202. Note that although the message 204 is shown as pre-affixed with the social communication device 202, the message 204 may allow for partial or total customization (typically written) by the person, or may be randomly or purposefully selected from a choice of pre-existing messages. Next, as shown in FIG. 2(b), a person 200 selects a delivery device 206 (e.g., a beer bottle) from a display of bottle options 208. Subsequently, as shown in FIG. 2(c), the person 200 attaches the social communication device 202 with the delivery device 206 using an adhesive. Then, as depicted in FIG. 2(d), the person 200 delivers the delivery device 206, with attached social communication device 202, to a recipient 210. Note that although the person 200 delivers the delivery device 206 directly to the recipient 210, such delivery may also be made through an intermediary (e.g., an agent, representative third party, or a machine). FIG. 2(e) shows the person 200 and the recipient 210 having an enjoyable conversation as a result of the delivery of the delivery device 206 with the social communication device 202 attached.

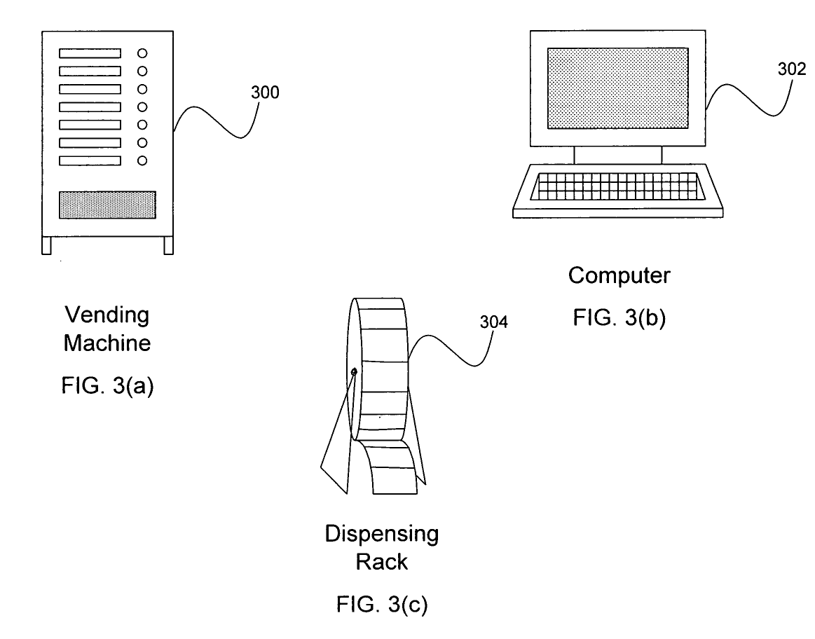

FIGS. 3(a) through 3(c) present non-limiting examples of mechanisms through which a social communication device 202 may be distributed. FIG. 3(a) illustrates an alternative where the vendor is a vending machine 300. FIG. 3(b) illustrates another alternative in which the vendor is a computer 302. Still further, FIG. 3(c) shows the vendor as a dispensing rack 304. Other non-limiting ways in which a social communication device 202 may be obtained include utilizing the Internet or an in-store display. By utilizing the Internet, a variety of social communication device types may simply be downloaded and printed for use (e.g., at a party) via a user's computer.

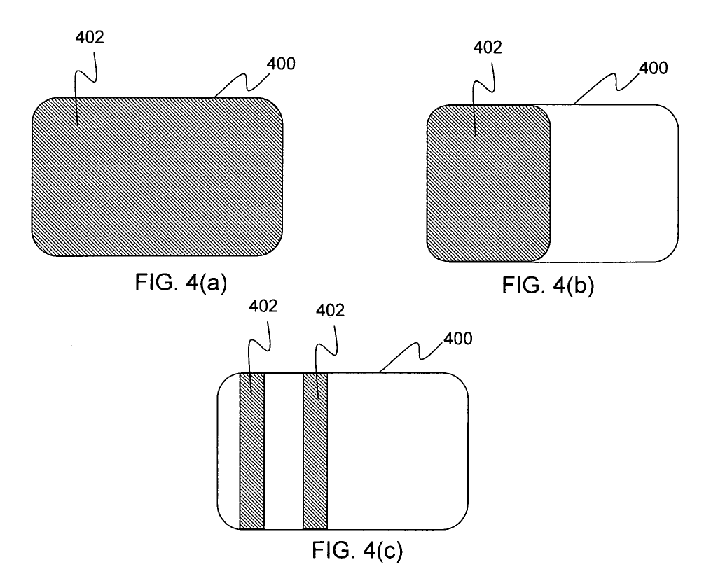

FIGS. 4(a) through 4(c) illustrate three non-limiting examples of labels with different patterns of adhesive material. Specifically, FIG. 4(a) presents an adhesive label 400 in which adhesive material 402 is distributed across the entire label. FIG. 4(b) presents another adhesive label 400 in which the adhesive material 402 is applied across approximately half of the label. Finally, FIG. 4(c) presents another adhesive label 400, where the adhesive material 402 is distributed in stripes on the back of the label, leaving part of the label with a non-adhesive surface.

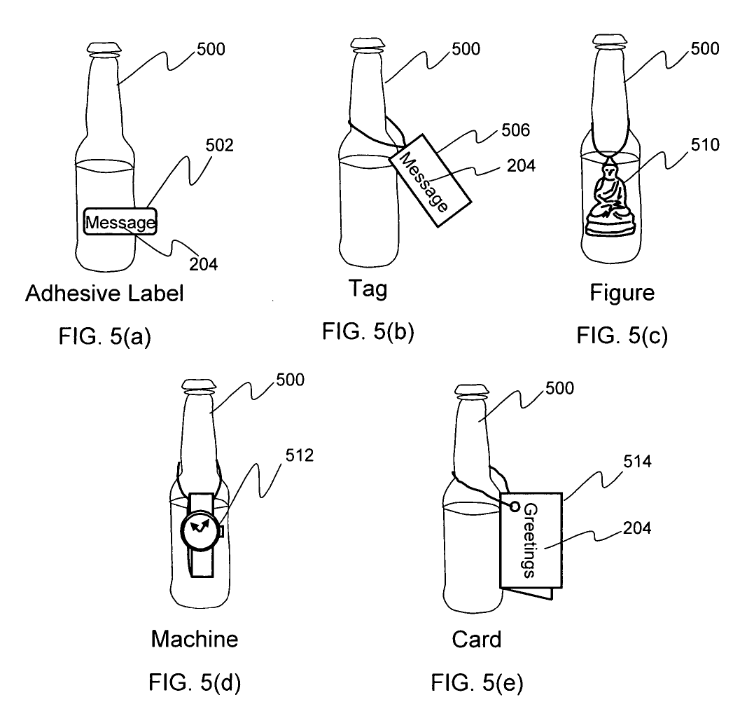

FIGS. 5(a) through 5(e) illustrate various non-limiting examples of a delivery device 500 with attached social communication devices 202 and affixed messages 204, where shown. FIG. 5(a) shows an example of a delivery device 500 having a social communication device 202 in the form of an adhesive label 502 with a message 204. As shown, the adhesive label 502 is attached directly with the delivery device 500. In this example, the message 504 is printed on the adhesive label 502. FIG. 5(b) illustrates an alternate example of a delivery device 500 with a social communication device 202 in the form of a tag 506 with a printed message 204. FIG. 5(c) illustrates another example of a delivery device 500 with a social communication device 202 in the form of a figurine 510 (figure/sculpture). FIG. 5(d) illustrates yet another example with the social communication device 202 in the form of a machine 512 (in this case, a small watch). FIG. 5(e) illustrates still another example of a delivery device 500 with a social communication device 202 in the form of a card 514. In this example, a message 204 is printed on the card 514. Although several examples of social communication devices 202 were shown in FIGS. 5(a) through 5(e), any suitable object may be used and the present invention is not intended to be limited to the examples shown. FIGS. 5(b) through 5(e) show hanging-type methods of attaching the social communication device 202 to the delivery device 500. Other methods of attachment may easily be envisioned, non-limiting examples of which include adhesives, hook-and-loop-type bindings (Velcro™), magnets, etc.

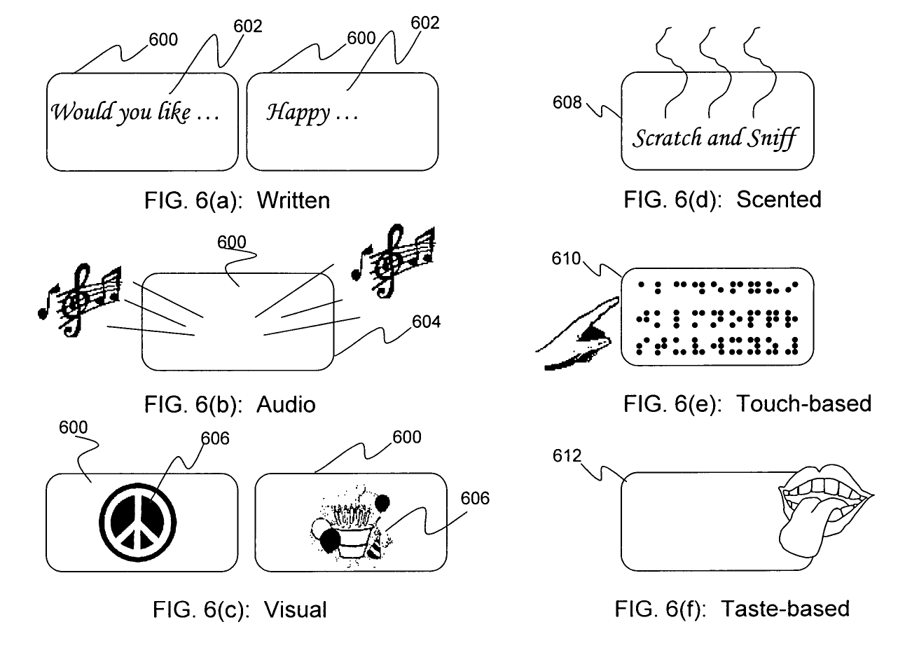

FIGS. 6(a) through 6(f) are illustrations of non-limiting examples of a message in accordance with the present invention. FIG. 6(a) shows two examples of stickers 600 according to the present invention, where the message 204 thereon is in the form of a written message 602. This written message 602 may be preprinted in whole or in part, so that a user can add content of his or her choosing. The written message 602 may also be partially or wholly created by the user. FIG. 6(b) presents another example, wherein the social communication device 202, again in the form of a sticker 600, emits an auditory message 604 (e.g., an audio recording). Recordings such as a song, a phrase, a poem, or a sound effect may be either prerecorded or recorded by the user before delivery. Further, FIG. 6(c) presents two examples of stickers 600 that include visual messages 606. Non-limiting examples of visual messages 606 that may be displayed on stickers according to the present invention include a drawing, a symbol, clip art, or a video clip. FIG. 6(d) illustrates a scented message 608. Non-limiting examples of scented messages 608 include scents that are continually released and those that are released following an action by a user (e.g., scratch-and-sniff). An example of a touch-based message 610 is shown in FIG. 6(e). The non-limiting example depicted shows a message with a texture or Braille. FIG. 6(f) illustrates a taste-based (flavored) message 612 (e.g., a flavored sticker or candy). The messages illustrated in FIGS. 6(a) through 6(f) may be combined to create more complex messages. For example, an audio/video message may be created by combining an auditory message 604 with a visual message 606.

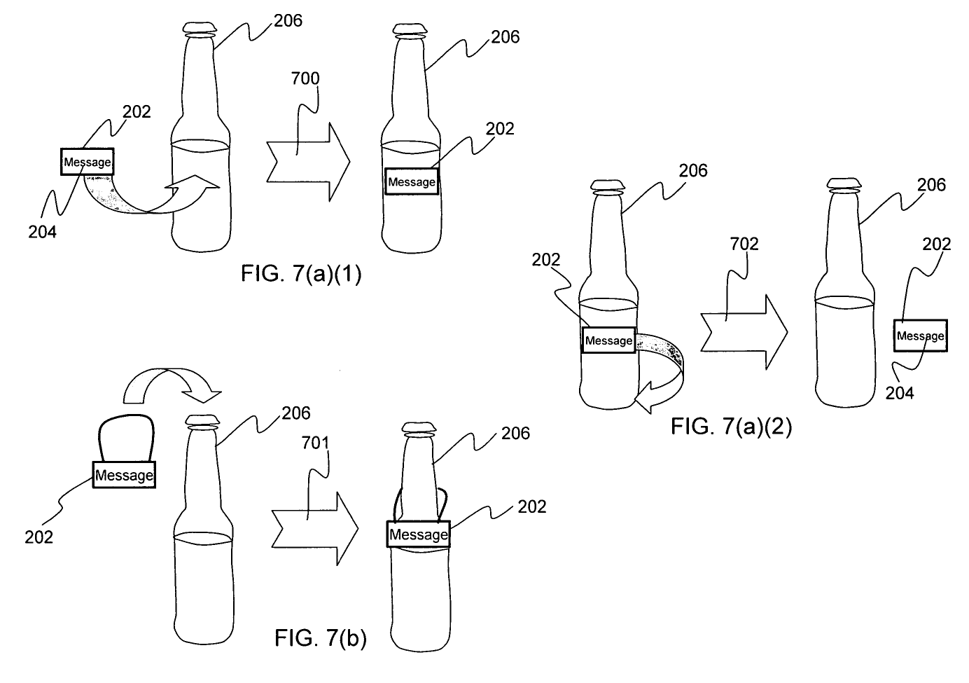

FIGS. 7(a) and 7(b) illustrate exemplary and non-limiting embodiments for attaching a social communication device 202 with a delivery device 206. FIG. 7(a)(1) illustrates the process of attaching 700 a social communication device 202 with a delivery device 206 by adhesion. Here, a social communication device 202, in the form of a preprinted message 204, is depicted as attached with a delivery device 206 in the form of a bottle. FIG. 7(a)(2) illustrates the process of removing 702 a social communication device 202 from a delivery device 206. In this case, where the social communication device 202 is in the form of a sticker and the delivery device 206 is in the form of a beverage container, the user simply peels the sticker off the beverage container. The social communication device 202 may also be removed from the delivery device 206 by dissolving it in water or some other adhesive-dissolving solution. FIG. 7(b) illustrates the process of attaching 701 a social communication device 202 to a delivery device 206 by hanging. In this case, the social communication device 202 is in the form of a tag hung over a portion of the delivery device 206.

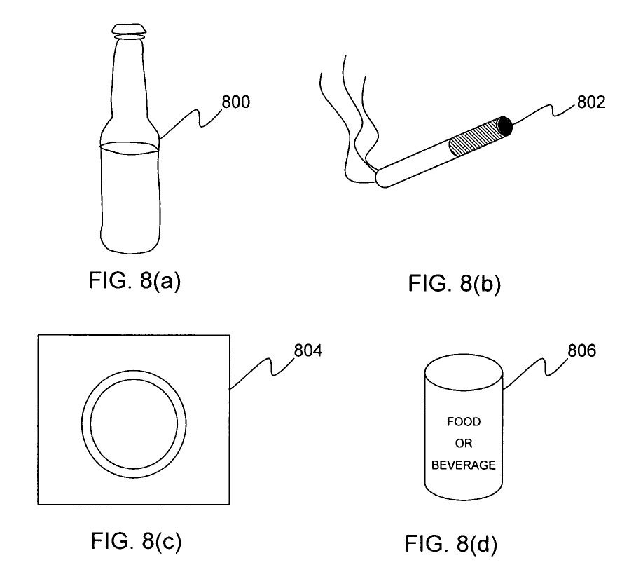

FIGS. 8(a) through 8(d) illustrate non-limiting exemplary embodiments of a delivery device 206. A delivery device 206 may be a drinking device 800 such as the bottle shown in FIG. 8(a). Other non-limiting examples of delivery devices 206 include a smoking device 802 such as a cigarette or a cigar, as illustrated in FIG. 8(b); a contraceptive device 804, as illustrated in FIG. 8(c); and a food or beverage container 806 such as a can, as illustrated in FIG. 8(d). It will be appreciated by one skilled in the art that this is an extremely limited set of examples and that many other items may be used as delivery devices 206 (other non-limiting examples include gelatin shots, ice cream cones, candy, test tubes, shot glasses, etc.). Delivery devices 206 may be obtained from a delivery device source such as a person 212, a machine (such as a vending machine 300), the Internet (by ordering online 302), a display such as an in-store display (for a non-limiting example, a dispensing rack 304), and from a retail store.

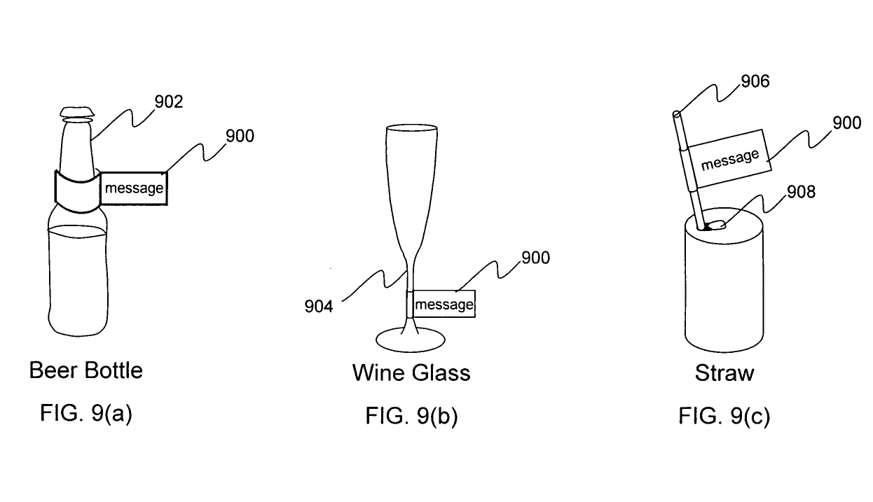

FIGS. 9(a) through 9(c) illustrate exemplary placements of social communication devices 202 on various delivery devices 206. In FIG. 9(a), a social communication device 202 in the form of a sticker 900 is attached with a neck of a beer bottle 902. In FIG. 9(b), a social communication device 202 in the form of a sticker 900 is attached with a stem of a wine glass 904. In FIG. 9(c), a social communication device 202 in the form of a sticker 900 is attached with a straw 906, where the straw 906 is placed in the mouth of a beverage can 908. In each of these cases, it is desirable that the social communication device 202 be placed on the delivery device 206 in a manner that makes it readily visible to a recipient.

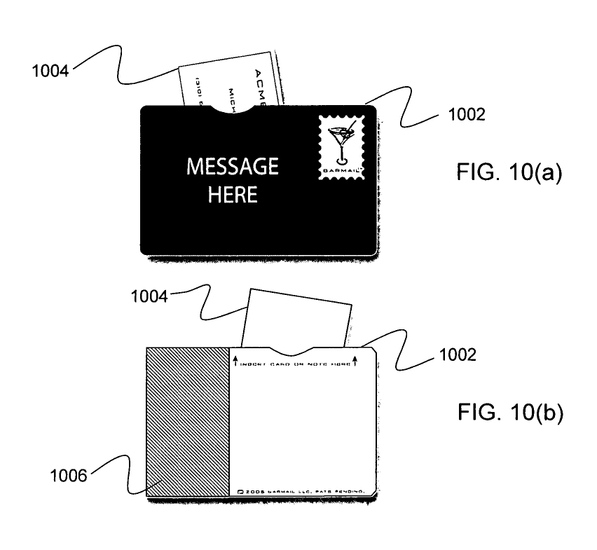

FIGS. 10(a) and 10(b) illustrate the front and rear views respectively of a non-limiting embodiment of a delivery device 206 in the form of a retainer for attaching a secondary message. In this example, the retainer is a pocket 1002 and the secondary message is a business card 1004. Additionally, the delivery device 206 may include an adhesive area 1006.

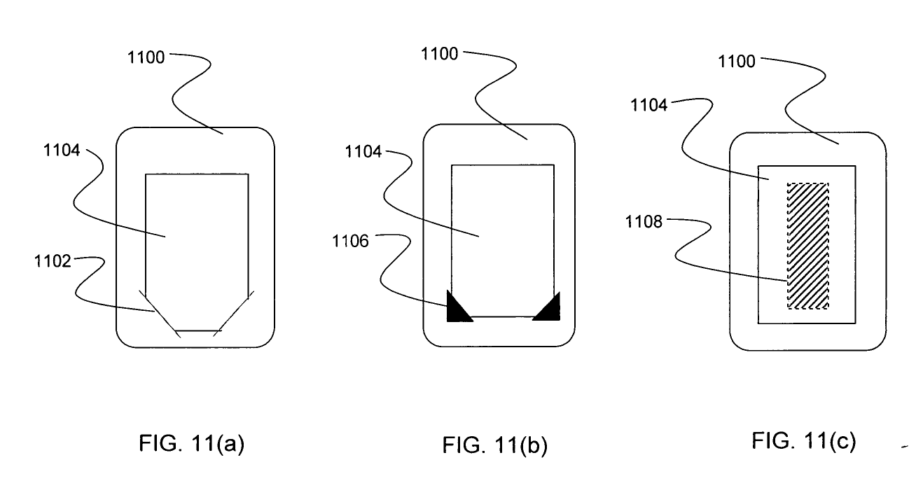

FIGS. 11(a) through 11(c) illustrate non-limiting examples of mechanisms of attachment, which may be used for attaching a backing 1100 with a secondary message. In these embodiments, the exemplary secondary message is in the form of a business card 1104. FIG. 11(a) illustrates the mechanism of attachment including at least one slit 1102. FIG. 11(b) illustrates the mechanism of attachment as plurality of corner pockets 1106. FIG. 11(c) illustrates the mechanism of attachment as an adhesive 1108 between the backing 1100 and a secondary message, which in this non-limiting example is a business card 1104.

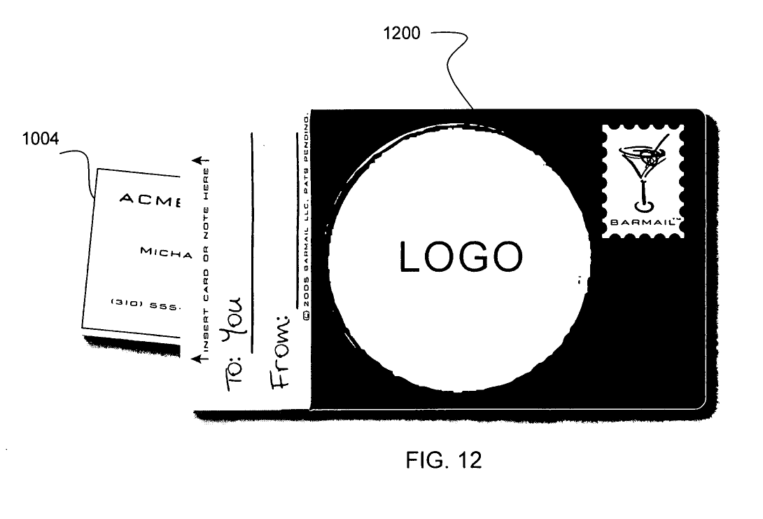

FIG. 12 illustrates a delivery device in the form of a coaster 1200. A secondary message, such as a business card 1004, may be attached with the coaster 1200. In this example, the delivery device 206 and the social communication device 202 are combined as a single unit.

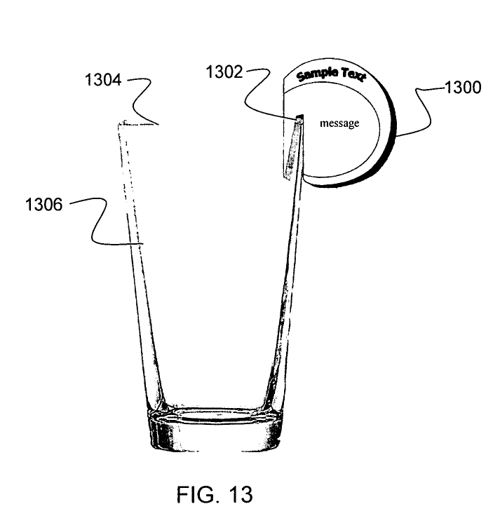

FIG. 13 is a detachable attachment where the detachable attachment is a slotted attachment 1300. The slot 1302 attaches to the lip 1304 of a container which, in this non-limiting example, is a glass 1306.

What is claimed is:

1. A method of facilitating social communication from a person to a recipient, the method comprising of:
obtaining a social communication device having at least one message selected by the person, from a group consisting of a pre-existing message, a random message, and a customizable message and when:
the message includes a customizable message, customizing the message;
selecting a delivery device;
attaching the social communication device with the delivery device;
delivering the delivery device to the recipient; and
whereby, social communication is facilitated between people.

2. A method for facilitating social communication as set forth in claim 1, where in the act of obtaining, the social communication device is obtained from a vendor.

3. A method for facilitating social communication as set forth in claim 2, where in the vendor is selected from a group consisting of a person, a vending machine, the Internet, a display, a container, a computer, and a dispensing rack.

4. A method for facilitating social communication as set forth in claim 1, where in the act of selecting a delivery device is obtained from a delivery device source.

5. A method for facilitating social communication as set forth in claim 4, where in the delivery device source is selected from a group consisting of a person, a machine, the Internet, a display, and a store.

6. A method for facilitating social communication as set forth in claim 1, where in the act of attaching the social communication device with the delivery device, the act of attaching is performed with a mechanism selected from a group consisting of a detachable attachment and a permanent adhesive.

7. A method for facilitating social communication as set forth in claim 6, where in when the mechanism is a detachable attachment, the detachable attachment is selected from a group consisting of an attachment, a hanging attachment, a slotted attachment, and a clip.

8. A method for facilitating social communication as set forth in claim 1, where in the act of delivering, the delivery device is delivered to the recipient by a deliverer.

9. A method for facilitating social communication as set forth in claim 8, where in the act of delivering, the deliverer is selected from a group consisting of the person, an agent/representative, and a machine.

10. A method for facilitating social communication as set forth in claim 1, where in the social communication device is selected from a group consisting of a label, a tag, a sculpture, a machine, a figure, a card, a retainer for attaching a secondary message, and an object.

11. A method for facilitating social communication as set forth in claim 1, where in the message is selected from a group consisting of a written message, an auditory message, a visual message, a scented message, a tactile message, and a flavored message.

12. A method for facilitating social communication as set forth in claim 1, where in the delivery device is selected from a group consisting of a smoking device, a drinking device, a contraceptive, a gelatin shot, a food container and a coaster.

13. A method for facilitating social communication as set forth in claim 12, where in the drinking device is selected from a group consisting of a bottle, a glass, a cup, a can, and a test tube.

14. A method for facilitating social communication as set forth in claim 10, where in the retainer is selected from a group consisting of a sheath, an envelope, a pocket, and a backing.

15. A method for facilitating social communication as set forth in claim 14, where in the backing includes an adhesive, corner pockets, and at least one slit.

16. A method for facilitating social communication as set forth in claim 10, where in the secondary message is selected from a group consisting of a card, a business card, money, a picture, a room key, and an object.
